(19) United States
(12) Patent Application Publication
(10) Pub. No.: US 2011/0230069 A1
(43) Pub. Date: Sep. 22, 2011

(54) COVER FOR AN AIRCRAFT TERMINAL BLOCK HAVING AT LEAST ONE TERMINAL

(75) Inventors: Jerome AUPHAND, Toulouse (FR); Jean-Luc BALLENGHIEN, Blagnac (FR)

(73) Assignee: AIRBUS OPERATIONS, TOULOUSE (FR)

(21) Appl. No.: 13/046,146

(22) Filed: Mar. 11, 2011

(30) Foreign Application Priority Data
Mar. 18, 2010 (FR) FR1051940

(51) Int. Cl. H01R 13/44

(52) U.S. Cl. 439/135

(57) ABSTRACT

The cover for an aircraft power terminal block having at least one terminal comprises two flanks extending facing each other. At least one of the flanks presents at least one removable portion integral with the flank and connected to the flank by side edges of the removable portion

### FIELD OF THE INVENTION

The invention relates to electrical terminal blocks for aircraft.

### BACKGROUND OF THE INVENTION

Future generations of airplanes will shortly be including high voltage electricity networks. These high voltages require several types of risk to be taken into consideration, and in particular the risk of electric shock. The electrical components that give access to those power networks will be located in various different zones of the airplane, including in zones where action may be taken by operators who are not trained in handling high-risk electricity. It is therefore desirable to preserve the safety of such people who need to act on board an airplane, and to do so in a manner that can be implemented easily and quickly.

In particular, it is necessary to prevent accidental electric shocks on power terminal blocks for making junctions and/or branch connections with electric cables that convey power at high current (several amps to several hundreds of amps), regardless of the voltage concerned.

### OBJECT AND SUMMARY OF THE INVENTION

To this end, the invention provides a cover for a power terminal block of an aircraft, the block including at least one terminal, which cover comprises two flanks extending facing each other, at least one of the flanks presenting at least one removable portion integral with the flank and connected to the flank by side edges of the removable portion.

Thus, so long as the or each removable portion has not been removed, it constitutes an obstacle to accessing the volume inside the cover and thus to accessing the terminals of the power terminal block. Nevertheless, given the removable nature of this portion, it is possible, at will, to free at least one location in the flank for passing at least one lug connected to a terminal. It is possible to cause a plurality of lugs connected to a given terminal to pass through a single location that has been freed in the flank. The cover allows the cable connected to the terminal to extend in a manner that is not accurately perpendicular, e.g. in order to accommodate particular installation conditions. Furthermore, when the block covered by the cover has a plurality of terminals, it is possible to put them to the same potential by connecting a shunt or branch connection. The cover thus provides protection against electric shock while being easy and quick to install. It constitutes a part that is adaptable and that can be varied during the lifetime of the aircraft, while allowing individuals to be protected. The cover may be used with various types of terminal block. It allows various types of connection to the structure of the terminal block. It is possible to form warnings in relief or by printing on the cover concerning potential danger. Furthermore, since the removable portion is formed integrally with the flank, assembly operations are avoided and fabrication of the cover is simplified.

Advantageously, each flank presents a plurality of removable portions.

Thus, the cover may cover a block having a plurality of terminals and it is possible, at will, to connect one or more of those terminals to respective lugs passing through the flank.

Preferably, the or each flank presenting a removable portion presents at least one pre-cut.

Thus, it is easy to remove the removable portion, including on site, prior to installing the cover on the block.

Preferably, the or each flank presenting a removable portion presents at least two pre-cuts for the or each removable portion, the pre-cuts being shaped to enable a dimension to be selected for the removable portion.

It is thus possible for the window that is released in the flank to be adapted to circumstances.

Preferably, the removable portion includes a free end edge of the cover.

This free edge facilitates detaching the removable portion. In addition, since the window is downwardly open, installation of the cover on the block is simplified.

Preferably, the cover includes a lid connecting together the flanks.

The lid thus protects the power terminal block from access from above. It may act as a single lid for the block, or it may extend over a cover that comes from elsewhere.

Preferably, the lid presents at least one ventilation orifice.

Thus, exchanges of gas and/or heat between the space inside the cover and the outside are encouraged, thereby avoiding rises in temperature and the accumulation of potentially dangerous substances.

Advantageously, the cover is made as a single piece.

The invention also provides a cover for an aircraft power terminal block having at least one terminal, the cover comprising two flanks extending facing each other, with at least one of the flanks presenting at least one movable portion.

Thus, unlike the above aspect of the invention, a passage is made available for a lug connected to one of the terminals by making a portion of a flank movable.

Provision may be made for the flank and/or the movable portion to be rigid.

Provision may also be made for the or each movable portion to be flexible.

This constitutes a particularly simple way of making the movable portion. It is moved by deforming it.

Advantageously, for the or each movable portion, the flank presents a window associated with the movable portion.

Preferably, the or each window is associated with a single movable portion.

This thus gives precedence to closing the flank properly when there is no lug passing through the corresponding location.

Advantageously, the or each movable portion forms a bellows.

This embodiment has the particular advantage of the movable portion occupying little space when it is moved out of the way to pass a lug.

The invention also provides an aircraft including at least one power terminal block having at least one terminal and a cover of the invention mounted on the block.

The invention also provides an assembly comprising a power terminal block for an aircraft having at least one terminal and a cover suitable for covering the block, and comprising two flanks extending facing each other, at least one of the flanks presenting at least one removable portion.

Finally, the invention provides a method of limiting access to a power terminal block having at least one terminal in an aircraft, wherein at least one location in at least one flank of a cover is released and the cover is installed in such a manner that the flanks extend on either side of the block and a lug of the block connected to the terminal or to one of the terminals extends through the location.

### BRIEF DESCRIPTION OF THE DRAWING

Other characteristics and advantages of the invention appear further from the following description of an embodiment and variants given as non-limiting examples and with reference to the accompanying drawing, in which:

FIGS. 1 to 3 are respectively an elevation view, a side view, and a plan view of a cover in an embodiment of the invention;

FIG. 4 is a perspective view of a power terminal block; and

FIG. 5 is a perspective view of an airplane of the invention.

### MORE DETAILED DESCRIPTION

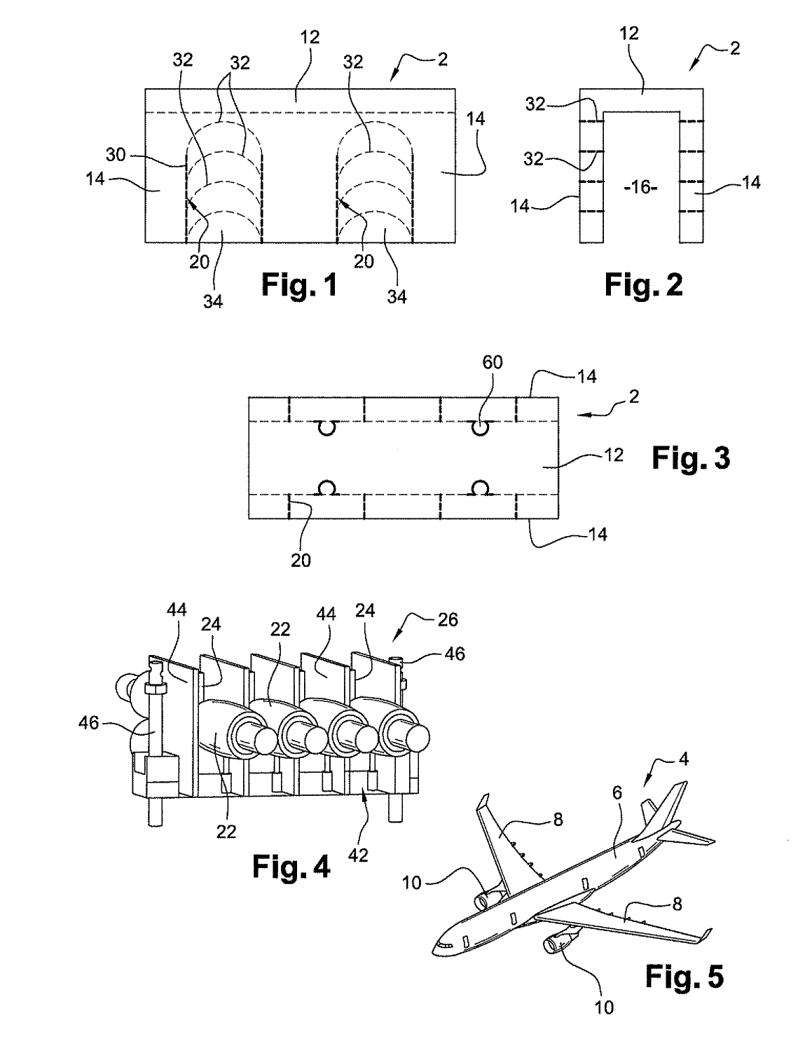

With reference to FIGS. 1 to 3, there follows a description of an embodiment of a cover 2 of the invention. The cover is for covering a power terminal block 26 presenting electrical connection terminals for connecting to lugs within an electricity network of an aircraft such as the aircraft 4 shown in FIG. 5. This aircraft is an aerodyne and specifically an airplane comprising a fuselage 6, two wings 8, and two jets 10 carried by respective ones of the wings.

The cover 2 comprises a lid 12 of a shape that is flat and rectangular in plan view. It has two flanks 14 likewise each of a shape that is flat and rectangular, but when seen in elevation view. The two flanks extend parallel to each other, facing each other, and spaced apart from each other, projecting from two longitudinal edges of the lid, on the same side thereof, and perpendicularly thereto. They thus co-operate therewith to define an enclosure 16 that is generally in the form of a rectangular parallelepiped. The cover 2 presents a longitudinal midplane of symmetry parallel to the two flanks and halfway between them, and also a transverse midplane of symmetry passing through the centers of each of the flanks and of the lid.

Provision may be made for the lid 12 to present orifices, each passing through the thickness of the lid so as to put the air inside the enclosure 16 into communication with the outside of the cover when it is covering the block, as described below. These orifices serve in particular to avoid overheating within the enclosure. Other orifices are provided for fastening the cover to the block.

Since the flanks 14 are symmetrical to each other, the description below relates to the flank shown in FIG. 1. It includes a plurality of locations defining openings or windows 20, each allowing one or more lugs 22 to pass therethrough, which lugs are connected to a pin 24 forming one of the terminals of the block 26 and visible in FIG. 4. The locations 20 are identical to one another and in this example there are two of them, with this number not being limiting. They follow one another along the cover. Each window 20 is associated with a removable shutter 34 that can be cut away, the shutter forming a removable portion of the flank. Each said location is occupied by a shutter that can be detached in order to free and form the window.

In this example, each window is generally arcuate in shape presenting two straight sides 30 that are parallel to each other and perpendicular to the plane of the lid, together with a curved top edge 32 providing a junction between the two edges 30 at their top ends. The window 20 occupies the major fraction of the height of the flank 14, in particular more than 75% of the height. The width of the window as defined by the space between the two edges 30 is selected to allow the window to pass the cross-section of a lug 22 that is associated with the block and that is covered by the cover. In this example, the height of the window is designed to allow two or three lugs 22 to pass through, one above the other.

The edges 30 and 32 of the windows 20 are defined and embodied by zones of local weakening, such as pre-cuts, the outsides of the windows forming the flank and the insides of the windows forming the shutters 34. For each window, a plurality of top edges 32 are provided that follow one after another, all of which top edges serve to connect together the side edges 30 of the window. The shutter 34 is removable, such that it can be detached from the flank by following the pre-cuts corresponding to the edges 30 together with a selected one of the pre-cuts 32 that corresponds to the top edge and that has been selected from amongst those that are available. Specifically, four pre-cuts are provided for the edge 32. The window 20 is thus freed once the shutter 34 has been detached along the pre-cuts. This selection is made as a function of the dimensions of the lug(s) connected to the terminal in question of the block. The pre-cuts are made so that each shutter 34 can be detached by hand or by using a light tool. In a variant, the zone of weakness may be formed by a zone of local thinning in the thickness of the flank. Each of the flanks and each of the shutters is rigid in this example.

Each shutter 34 is connected continuously to the window all along its edges 30 and is formed integrally with the flank that carries it. It occupies all of the corresponding window. The thickness of the shutter 34 is identical to the thickness of the flank in the present example and coincides therewith, the shutter lying in the same plane as the flank.

The cover 2 may be made as a single piece of a rigid material. In this example it is a single piece of a synthetic material such as a thermoplastic material. Alternatively, the flanks 14 and the lid 12 may be fabricated independently and fastened together, e.g. by snap-fastening each flank into the lid via snap-fastener members 60 on the flanks engaging appropriate recesses formed in the lid.

The block 26 is designed to receive the cover 2 and comprises a base 42 carrying the pins 24 that constitute as many terminals for connection to lugs 22 that are carried by electric cables for connection to the block. The block 26 has plane separators 44 extending facing one another and spaced apart from one another, being mutually parallel. Each separator extends between two successive terminals 24. At each of its ends, the block 26 includes a pillar bolt 46.

Before installing the cover on the block and given the presence of lugs on the block, the removable portions 34 that need to be removed are removed, and the pre-cuts 32 are selected correspondingly as a function of the dimensions of the window that is to be freed. In order to install the cover 2 while the lugs 22 are in place on the block, the cover is placed over the block 26 in such a manner that the space 16 faces the pins 24 and the separators 44. The cover is lowered onto the block until the inside face of the lid comes to bear against the top edges of the separators 44, the flanks 16 facing the vertical edges thereof. The cover thus covers the block and its terminals, both laterally with its flanks and on top with its lid. Once the cover is in place on the block, it is fastened securely to the bolts 46 via some of the orifices, e.g. by quarter-turn fastener members.

It is possible to provide such a cover for a block 26 that has only one terminal 24, or on the contrary for a block that has a plurality of terminals. Preferably, the cover is fabricated so as to be compatible with the longest expected blocks, e.g. in a version for a twelve-terminal block. Prior to being put into place, it is possible to cut the cover to the desired length in order to eliminate any excess segment.

The cover provides protection against access to the terminals of the block by forming an obstacle to such access. The obstacle is formed by the flanks, the shutters, or both of them. The cover thus serves to reduce the risk of electric shock when the block is live. This protection is provided by the cover regardless of the number of lugs that are connected to the block, and even when there are no lugs connected to the block. Under such circumstances, all of the shutters occupy the corresponding windows in full. Although the cover described above is a cover for providing protection against accessing the terminals from above, provision may be made to use additionally the cover originally associated with the block, so that the lid 12 extends thereagainst.

Good sealing between the lugs and the flanks in the windows is not desired so as to enhance the exchange of gas and heat, so as to make it possible to use lugs, cables, and sheaths that are of a variety of dimensions, and finally so as to allow the materials to deform while the cover is being installed on the block.

The cover may be removed at will when there is a need to access the block.

The cover may be placed on a block in which the terminals are arranged in one or two rows.

Visible faces of the cover, e.g. on the lid or on the flanks may include warnings such as “high voltage” or symbols representing the danger in question. Such warnings may be formed in relief in the material of the cover, they may be printed using ink or a laser, or indeed they may be printed on stickers. By way of example the cover may have a height of 45 millimeters (mm), a width of 90 mm, and a length of 100 mm or 200 mm. Each flank may have a thickness of about 2 mm. Each pin may have a shank with a diameter of about 11 mm.

In a variant, each window corresponds to a one-piece shutter that is movable relative to the flank and that is fastened to the flank solely via the top edge. Each shutter can thus be deformed so as to be lifted from the edges to allow at least one lug to pass through the corresponding window.

In another variant, each shutter has a bellows configuration with a zigzag profile and is made of a flexible material such as silicone. The flexible material and the zigzag shape enable the shutter to deform so as to be folded and compressed in an upward direction, thus enabling it to take up a retracted configuration in which it frees one of the locations. In its extended configuration, the shutter occupies the corresponding location.

In another variant, provision may be made for each shutter to present a straight middle cutout extending over the full height of the shutter from the bottom edge of the flank up to the curved edge, together with straight lateral cutouts extending from a middle segment of the cutout towards the edges of the window. While being put into place, at least some of the shutters come into contact with the lugs, thereby deforming the shutters and expelling the various portions thereof out from the corresponding window and the plane of the flank. Each flank is made of a flexible synthetic material, e.g. of silicone, being molded onto the lid, which is itself made of a thermoplastic material.

In these embodiments, the cover does not include any metal material, thereby avoiding problems of corrosion in association with the materials forming the block.

Naturally, numerous modifications may be made to the invention without going beyond the ambit thereof.

What is claimed is:

1. A cover for a power terminal block of an aircraft, the block including at least one terminal, wherein the cover includes two flanks extending facing each other, at least one of the flanks presenting at least one removable portion integral with the flank and connected to the flank by side edges of the removable portion.

2. A cover according to claim 1, wherein the or each flank presenting a removable portion presents at least one pre-cut.

3. A cover according to claim 1, wherein the or each flank presenting a removable portion presents at least two pre-cuts for the or each removable portion, the pre-cuts being shaped to enable a dimension to be selected for the removable portion.

4. A cover according to claim 1, wherein the removable portion includes a free end edge of the cover.

5. A cover according to claim 1, wherein a lid connecting together the flanks.

6. A cover according to claim 5, wherein the lid presents at least one ventilation orifice.

7. A cover according to claim 1, which cover is made as a single piece.

8. An aircraft, including at least one power terminal block having at least one terminal, and a cover according to claim 1, mounted on the block.

9. An assembly comprising a power terminal block for an aircraft having at least one terminal and a cover suitable for covering the block, wherein the cover has two flanks extending facing each other, at least one of the flanks presenting at least one removable portion.

10. A method of limiting access to a power terminal block having at least one in an aircraft, wherein at least one location in at least one flank of a cover is released and the cover is installed in such a manner that the flanks extend on either side of the block and a lug of the block connected to the terminal or to one of the terminals extends through the location.
